(19) United States
(12) Patent Application Publication
(10) Pub. No.: US 2015/0246549 A1
(43) Pub. Date: Sep. 3, 2015

(54) Replaceable Ink Cartridge with Reusable Memory

(71) Applicants: David M. Price, Loveland, CO (US); Gabriel Joseph Martinez, Denver, CO (US); Ryan Warren Ransburg, Boulder, CO (US); Timothy Graham Bradley, Longmont, CO (US); John Charles Wilson, Longmont, CO (US); Kenneth Stuart Shouldice, Firestone, CO (US); Daniel Ioan Ardelian, Timisora (RO); Roshmi Bhaumik, Longmont, CO (US)

(72) Inventors: David M. Price, Loveland, CO (US); Gabriel Joseph Martinez, Denver, CO (US); Ryan Warren Ransburg, Boulder, CO (US); Timothy Graham Bradley, Longmont, CO (US); John Charles Wilson, Longmont, CO (US); Kenneth Stuart Shouldice, Firestone, CO (US); Daniel Ioan Ardelian, Timisora (RO); Roshmi Bhaumik, Longmont, CO (US)

(73) Assignee: Ricoh Company, Ltd., Tokyo (JP)

(21) Appl. No.: 14/193,233

(22) Filed: Feb. 28, 2014

(51) Int. Cl. B41J 2/175

(52) U.S. Cl. CPC B41J 2/17546

(57) ABSTRACT

An apparatus is disclosed. The apparatus includes a cartridge with a fluid container, a nozzle attached to the fluid container to provide fluid from the container to a printer, a cartridge identification card to identify the fluid in the fluid in the container to the printer when the cartridge identification card is connected to the printer, and a strap having two ends, a first end being attached to the fluid container and a second end being attached to the cartridge identification card.

### FIELD OF THE INVENTION

The present description relates to the field of ink cartridges for printers and, in particular to ink cartridges with memory devices for.

### BACKGROUND

In many printers, a three liter cartridge is used to provide ink to an ink jet. The cartridge has an ink bag made from a gas impermeable material, a nozzle, to provide ink from the bag, a memory card holder, and a memory card on the holder. The memory card establishes an electrical connection to the printer through contact pads on the card. This is used to allow microcode logic to be executed on the printer to verify the installation of the fluid cartridge and to validate the type and color of the ink fluid.

The memory card is permanently connected to the removable cartridges. Each time a cartridge is replaced, the old memory card is mechanically disconnected. A new memory card on the cartridge establishes an electrical connection through multiple contact point points on the memory card. The cartridge must be properly positioned to allow the memory card to connect to the printer. The connection of the memory card activates the system to obtain the correct data from the cartridge memory card.

### SUMMARY

An apparatus is disclosed. The apparatus includes a cartridge with a fluid container, a nozzle attached to the fluid container to provide fluid from the container to a printer, a cartridge identification card to identify the fluid in the fluid in the container to the printer when the cartridge identification card is connected to the printer, and a strap having two ends, a first end being attached to the fluid container and a second end being attached to the cartridge identification card.

### BRIEF DESCRIPTION OF THE DRAWINGS

A better understanding of the present invention can be obtained from the following detailed description in conjunction with the following drawings, in which:

FIG. 1 is a block diagram of one embodiment of a printing network;

FIG. 2 is a block diagram of one embodiment of the printer of FIG. 1 according to an embodiment of the invention;

FIG. 3A is an exploded diagram of an ink cartridge according to an embodiment of the invention;

FIG. 3B is an isometric drawing of an ink cartridge in a tray according to an embodiment of the invention;

FIG. 4 is a diagram of contact pads on a current loop interface for an ink cartridge according to an embodiment of the invention;

FIG. 5 is an exploded diagram of an interconnect card to connect to an current loop interface according to an embodiment of the invention;

FIG. 6 is a diagram of a user interface for using fluid cartridge according to an embodiment of the invention;

FIG. 7 is a process flow of replacing a fluid cartridge according to an embodiment of the invention;

FIG. 8 is a process flow of a machine reset operation when a fluid cartridge is replaced;

FIG. 9 is a block diagram of a computer system.

### DETAILED DESCRIPTION

An ink fluid cartridge has a flexible, strap attached to a PCB. The PCB has a fluid parameter identification scheme which activates an electrical subsystem of a printer. The PCB includes a fluid memory device, which interacts with controlling machine microcode of the printer. A related computer-based control system may also have a GUI (Graphical User Interface) fluid level reset function.

A system and method are described for using a PCB that is flexibly attachable to an ink cartridge. The different PCB pins identify cartridge ID (Identification) parameters such as color, type, etc. The PCB activates an electrical subsystem of a printer including a fluid memory device which in turn interacts with a printer control system GUI that can be used to reset the fluid level. The PCB can be attached with the use of a flexible strap and provides reliable connectivity in order to verify fluid cartridge installation and validation of fluid parameters. A memory card is permanently connected and mounted inside the printer instead of being mounted to the ink cartridge. This increases system stability. A system console or control system GUI provides the ability to give the user a single-click fluid content reset function which is only available when a new cartridge is installed.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

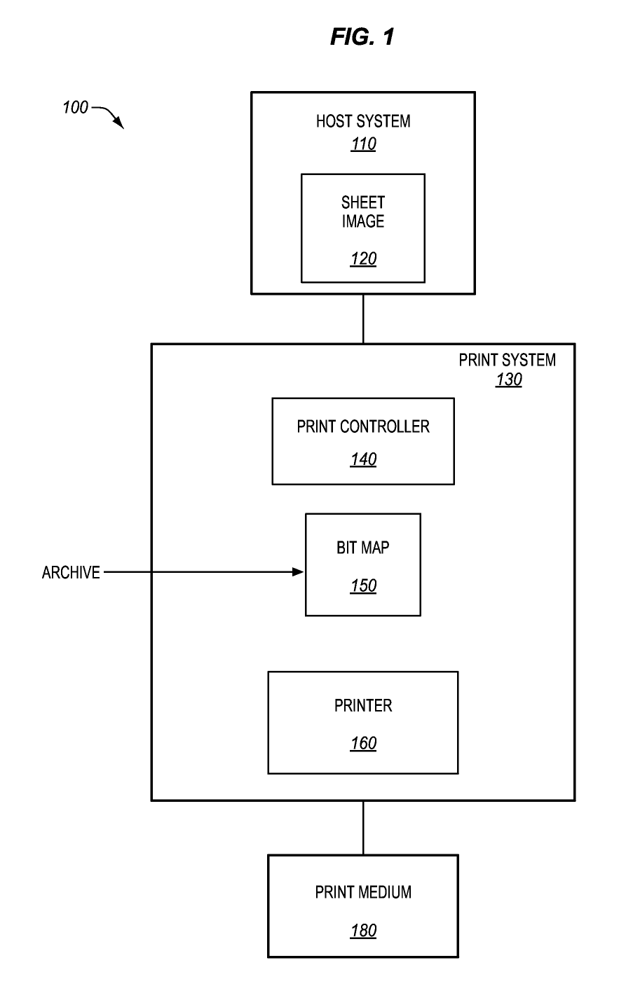

FIG. 1 is a block diagram illustrating a printing network 100. Network 100 includes a host system 110 in communication with a printing system 130 to print a sheet image 120 onto a print medium 180 (e.g., paper) via a printer 160. The resulting print medium 180 may be printed in color and/or in any of a number of gray shades, including black and white.

The host system 110 may include any computing device, such as a personal computer, a server, or even a digital imaging device, such as a digital camera or a scanner. The sheet image 120 may be any file or data that describes how an image on a sheet of print medium should be printed. For example, the sheet image 120 may include PostScript data, Printer Command Language (PCL) data, Intelligent Printer Data Stream (IPDS) and/or any other printer language data. The print controller 140 processes the sheet image to generate a bitmap 150 for printing to the print medium 180 via the printer 160.

The printing system 130 may be a high-speed printer operable to print relatively high volumes (e.g., greater than 100 pages per minute). The print medium 180 may be continuous form paper, cut sheet paper, and/or any other tangible medium suitable for printing. In one embodiment, the printing system 130 includes the printer 160 that presents the Bit Map 150 onto the print medium 180 (e.g., via toner, ink, etc.) based on the sheet image 120. A branch from the Bit Map stage 150 illustrates archiving. The archiving may be to a separate system or to the host system 110, for example.

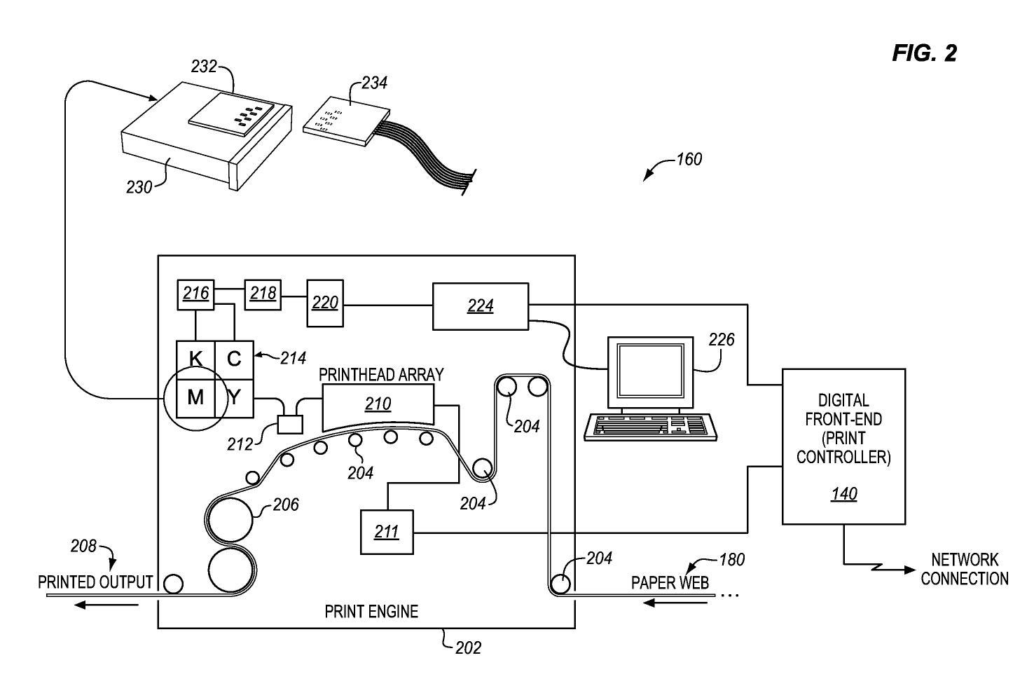

The print controller 140 may be any system, device, software, circuitry and/or other suitable component operable to transform the sheet image 120 for generating the Bit Map 150 in accordance with printing onto the print medium 180. FIG. 2 is a block diagram illustrating an exemplary print controller 140.

Referring to FIG. 2, the printer 160, in its generalized form, includes a print engine 202. The print engine, as described above is coupled to a print controller 140 which may be integrated into the printer or in a separate chassis. The print controller may be networked to other print engines or other devices to control print jobs and to perform additional image processing to support the print engine.

The print engine receives paper 180 or any other print medium from an external supply, such as a roll or stack. The paper is fed on rollers 204 to a print head array 210 which applies ink to the paper. The print medium is further fed by rollers to e.g. drum dryers 206 or any other final preparation process and then is delivered from the print engine as printed output 208.

The print head is supplied by ink canisters 214. There may be one for each of four different color components K, C, M, Y. Depending on the particular print technology there may be more or fewer of different types of inks. The ink canisters supply ink to an ink supply 212 which feeds the ink to the print head array 210. Each ink canister has one or more an ink cartridge or ink bags. In the illustrated example, the ink canister is provided with a drawer 230 that can be removed to replenish the ink supply.

In the illustrated embodiment, an ink bag is placed in an ink drawer. A printed circuit board 232 supplied with the ink bag is coupled to a cable connector 234. The cable, such as a ribbon cable or other multiple conductor cable, whether parallel or serial, is coupled to an interconnect card 216 of the print engine 202. The interconnect card provides information about the ink to an ink controller 218. The ink controller is coupled to a main print engine board 220 that is coupled to a printer management computer.

The printer management computer can be accessed through a printer console 226 which provides a human interface such as keyboard and monitor or other type of human interface, whether wired, wireless, local, or remote. The printer console 226 allows an operator to manage printer status, including ink types, amounts, and levels by accessing the printer management computer. The print engine and related components are not intended to be limited to any particular implementation as such may be a matter of design choice.

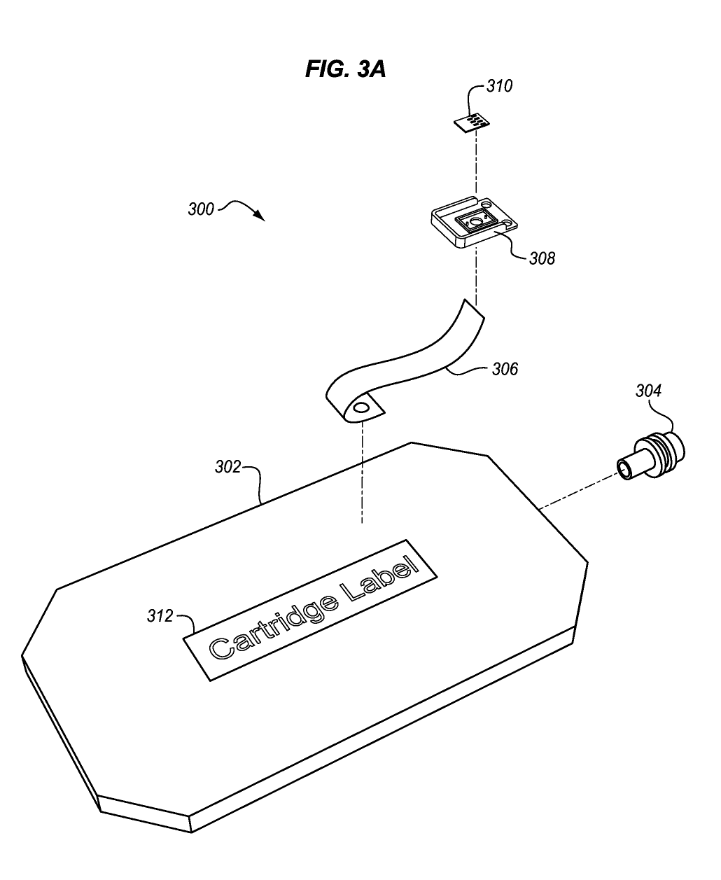

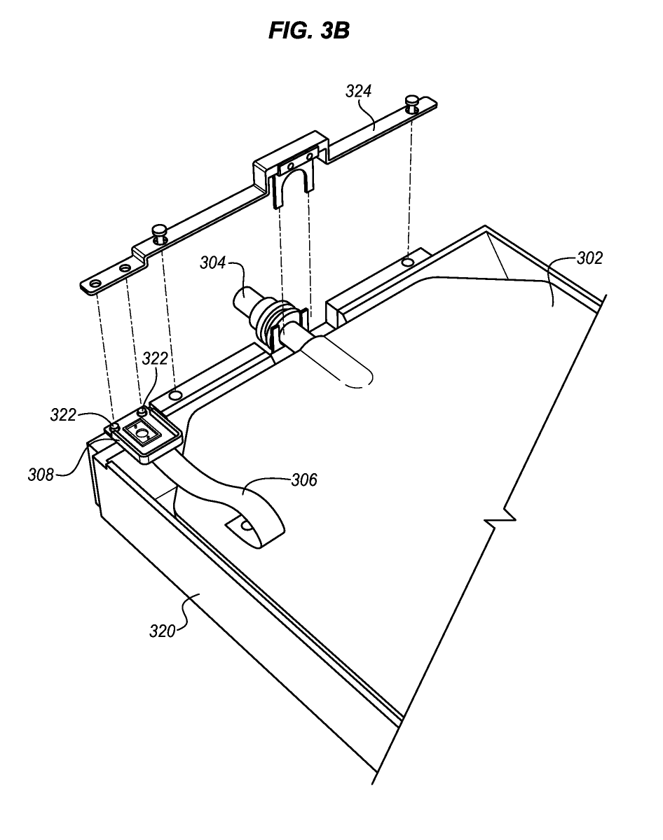

FIG. 3A shows an ink cartridge 300 such as a three liter (3L) ink cartridge, made from a gas impermeable material. The cartridge includes an ink bag 302, a nozzle 304, and a strap 306 connected at one end to the ink bag. The cartridge typically carries a label 312 to identify the contents of the bag, manufacturing details, model numbers and any other useful information. The strap may be made from any of a variety of different materials that are able to withstand the heat and the moisture of the environment inside the printer. The strap may also be made from dielectric or electrically insulating materials, such as Mylar, nylon, and polyester, etc. While an ink bag is shown, the fluid may be carried in any of a variety of other structures of different shapes and sizes to fit with different printers.

The strap carries a printed circuit board (PCB) holder 308 at the end opposite the bag. The PCB holder carries a PCB 310. The PCB, in the illustrated example will be referred to as a Current Loop Interlock Printed Circuit Board (CLI PCB). The CLI PCB establishes electrical connectivity using contact pads on the PCB 310. The CLI PCB is configured so that there is a current loop between two of the contact pads. The electrical connectivity between the two pads enables microcode logic to be executed in the printer, such as by the printer management computer, to verify fluid cartridge installation and to validate the type and color of the ink fluid, as well as any other desired parameters, depending on the particular implementation. The CLI may be used by the printer as an interlock so that the printer cannot be operated unless the correct current loop is detected. This prevents the printer from operating when cyan ink is installed where magenta ink should be, for example.

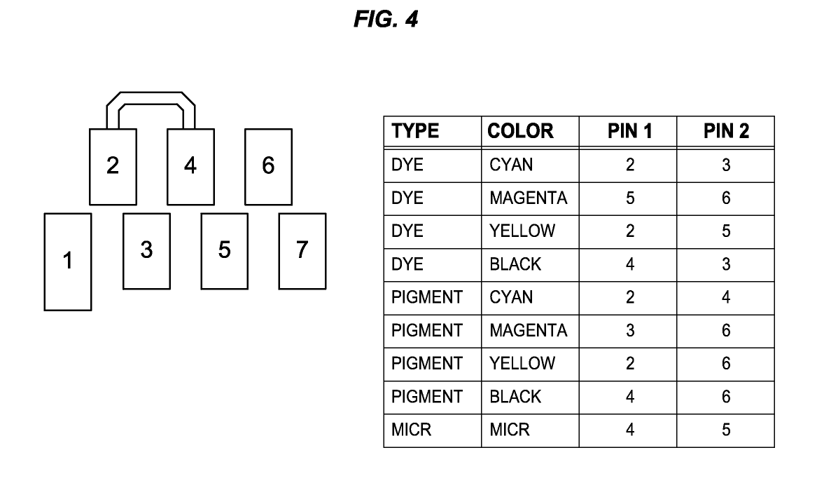

The CLI PCB serves as a fluid cartridge identification card. In this example, the card is in the form of a PCB with contact pads that establish a current loop. However, the cartridge identification card may take many different forms and may be fabricated using many different materials. A variety of different plastics and glass materials may be used as the substrate and different structures may be used to form the connection points. Alternatively, the cartridge identification may be formed using a different technology, such as magnetic, optical, or radio. The information carried by the CLI PCB may be limited to the type of fluid and the color as indicated in the table of FIG. 4, or it may include any additional manufacturing details, depending on the particular implementation. As an example, a date and location of manufacture, serial and batch numbers as well as model numbers may also be included.

FIG. 3B is an isometric view of a portion of the ink cartridge of FIG. 3A in a drawer 320. In one embodiment, the PCB 310 is attached into a plastic molded part or holder 308 to which one end of the strap 306 is attached. The other end of the strap is attached to the bag. This provides greater flexibility than attaching the PCB and plastic chip holder directly to the bag. When the ink cartridge is installed into the print engine 202, the ink container 302 first gets laid into an ink tray or drawer 320. This is a sheet metal or plastic tray in which the bag of the ink container sits. The nozzle 304 is coupled into a nozzle opening in the machine. The plastic chip holder 308 that is on the end of the strap is placed against, for example, some locating pins 322. This locates the contact pads of the CLI PCB 310 against a connector on the print engine when the drawer is placed into its place in the print engine. One or more retainers, clips, covers, or other components 324 may be placed over the nozzle and the PCB and snapped, locked, or fastened in place to hold the nozzle, PCB, and even the ink bag in place in the drawer when the drawer is placed into an ink canister of the print engine. The PCB may be held in place in any of variety of other ways, depending on the particular implementation.

The CLI PCB holder 308 is designed to position the CLI PCB 310 accurately and repeatedly for locating and maintaining electrical contact with the printer's electrical subsystem. While a particular design and connection interface is shown for the CLI PCB. Any other design may be used. The CLI PCB controls the use of the bag or fluid container with a specific fluid in a specific application. It may be used to prevent the user of an improper fluid or cartridge in any particular location. The strap attachment provides flexibility in the positioning of the electrical interface relative to the fluid interface, e.g. the nozzle. The holder may be coupled to the printer in any of a variety of different locations without affecting the connection of the nozzle for fluid flow. However, because of the strap, each CLI PCB is fixed to a particular fluid and cartridge.

The contact pads of the CLI PCB may be used to provide unique identifier codes for different materials, such as fluids and inks that are used by the fluid consuming device, such as the print engine of FIG. 2. FIG. 4 shows an example of how the contact pads of the CLI PCB 310 may be used to identify different types of color and inks to a printer. In this example there are seven contact pads labeled 1-7. Any two of the contact pads may be connected together using a solder line, a jumper, a DIP switch or another technique or structure. This provides for 21 different combinations of two different contact pads. For more combinations more contact pads may be used or the system may be configured to read combinations of two pads and three pads, etc.

FIG. 4 is a diagram of a set of contact pads 1 through 7 of a CLI PCB 310. While seven contact pads are shown, there may be more or less depending on the needs of a particular printer and cartridge system. Different types of fluids may be identified using contact loop combinations as shown in the table of FIG. 4. The table provides a variety of different type and color combinations. In the illustrated example contacts 2 and 4 are connected. As shown in the table, this example corresponds to pigment ink, cyan in color. The table is provided only as an example, any variety of different types, colors, and other characteristics may be designated using the contact pads. While the contact pads provide a simple system for identifying fluids in the bag, other systems may alternatively be used including serial, parallel, optical, RF (radio frequency) and magnetic identification systems.

The electrical subsystem of the printer may be configured so that it is activated when a CLI PCB is installed. The electrical subsystem may have a mechanical switch that is activated by the PCB or the holder. Alternatively, the subsystem may have a switch that is activated by one or more of the contact pads. In another embodiment, the printer is configured to use only one type of fluid in each ink bag location. When the PCB holder is inserted into its slot in the printer's electrical subsystem, a circuit is closed by the two connected electrical contact pads on the CLI PCB. If the correct two contact pads are connected, then the system is activated. Otherwise, the system remains “off.” This indicates that the correct cartridge has not been detected.

In other words, the printer has a memory card to which the CLI PCB is connected. The memory card has a pin for contact pad 2 and another pin for contact pad 4. If the memory card detects that these two contact pads are connected through the two pins, then it recognizes the cartridge as being of the correct type. The memory card does not need pins for any of the other contact pads because none of the other pins are used for this cartridge location. At another cartridge position, the memory card will recognize only another ink cartridge, such as one with contact pads 2 and 6 connected.

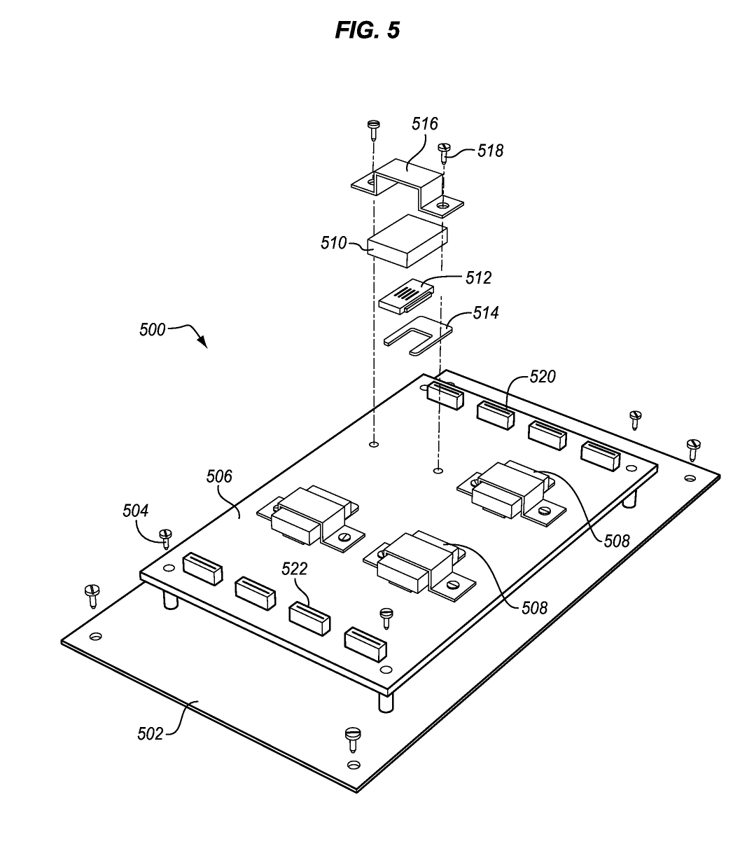

FIG. 5 is a diagram of a memory card that connects to the CLI PCB. The memory card may be permanently connected and mounted inside the printer instead of being attached to removable cartridges. This provides increased stability and reliability by avoiding the repeated mechanical connections and disconnections that would occur if the memory card were replaced with each ink cartridge replacement. While the memory card has multiple electrical connection contact points to the printer, the CLI PCB only requires two electro-mechanical contact points to the memory card. This means that there is less wear and fewer points of failure.

The memory card may be activated when a cartridge is inserted into position and a CLI PCB containing the correct connection pattern is connected to the memory card. In the illustrated example, the CLI PCB is connected to a cable in the ink drawer. The other end of the cable is connected to the memory cards. The correct pattern is verified by an internal interconnect PCB where the memory devices are permanently mounted. In one embodiment, an array on the memory card containing 0-ohm resistors allows the system to “power on” when the correct CLI PCB pattern is inserted to connect to the memory card.

In the example of FIG. 5, an interconnect card 500 has an interconnect PCB 506 attached to a mounting bracket 502 using fasteners, such as screws 504, clips, adhesive or any other fastener. The mounting bracket is mounted to the printer near where the cartridge is installed so that the interconnect card is within reach of a cable connection to the CLI PCB. Alternatively, the interconnect card may be located close enough for a direct connection.

The interconnect PCB carries one or more memory cards 508 to connect to a CLI PCB. The memory cards include a memory chip 510 and a connector card 512 to connect to the CLI PCB. The two pieces, chip and card, are held by a retainer 516 above and a bracket 514 below and attached to the interconnect PCB using fasteners, such as screws 518 through the retainer to hold the retainer against the bracket. Alternatively, adhesive, solder, rivets, or any other type of fastener may be used. While the interconnect card is shown as having four memory cards 508, only one is used at a time. More or fewer memory cards may be used, depending on the design of the particular printer and fluid system.

The interconnect PCB further includes ribbon cable connectors 520 to couple each memory card to a respective cable from an ink cartridge. The cable connectors are each coupled to a respective one of the memory devices through the interconnect PCB. In one example an eight conductor ribbon cable connects to the CLI PCB of an ink cartridge at one end and connects to a ribbon cable connector at its other end. Each of the four memory cards may be used for a respective one of the ink cartridges. If the appropriate connections on the ribbon cable are made through the CLI PCB, then the corresponding memory device is able to recognize and accept the ink cartridge.

If the wrong connections are made on the CLI PCB through the ribbon cable, then the memory card may indicate an error to the printer management computer 224 which can be signaled to the printer console 226. The error may be corrected by the operator. The interconnect PCB may have more or fewer memory devices, depending on the particular needs of the print engine. In one embodiment, there are two interconnect cards. Each card supports four cartridges. The four cartridges may be two cartridges of two different colors or one cartridge each of a different color or any other combination. The print engine carries two ink cartridges for each color which each connect to an interconnect card and in this example there are two interconnect cards with two colors each. The memory devices may be combined or a more complex device may be used to recognize more than one ink cartridge.

The interconnect PCB further includes a second set of ribbon cable connectors 522 to connect the memory devices to the ink controller 218. The memory devices are each coupled to a respective one of the cable connectors through the interconnect PCB. The ink controller 218 provides ink status and other data to the printer management computer 224 through the main board 220 or another connection. While ribbon cables and ribbon cable connectors are described herein, any other type of cable, serial or parallel, may be used, depending on the particular implementation.

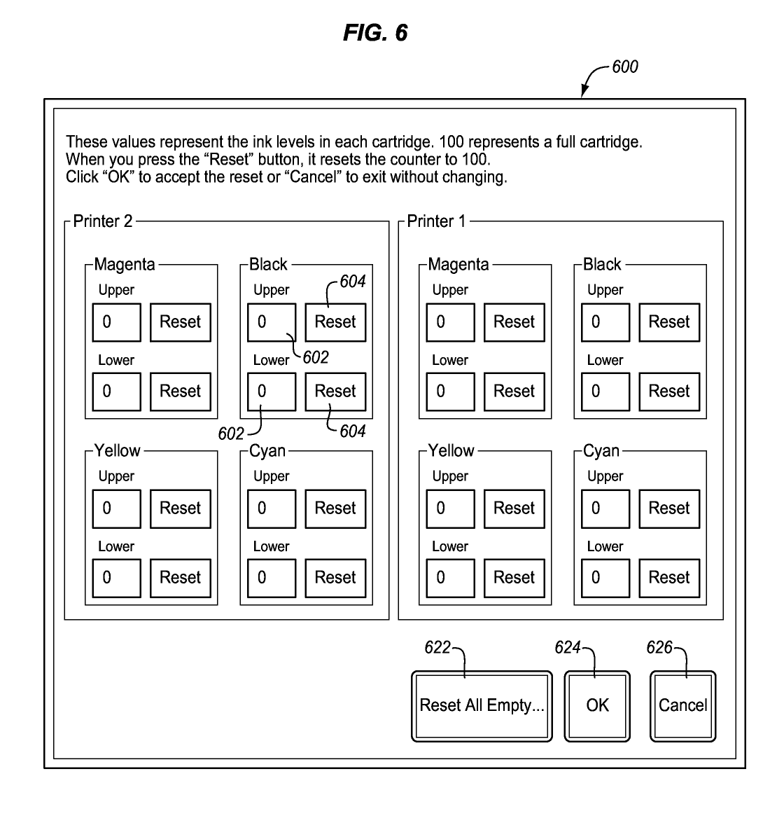

FIG. 6 shows a system console GUI (Graphical User Interface) 600 for servicing the printer. Such a GUI may be generated by the print management computer 224 and provided for example by the printer console 226. The printer console has a user interface such as a display and keyboard that may be directly connected to the print engine through the print management computer or connected through a wired or wireless remote connection, such as through a local area network.

When a new fluid cartridge is installed and a new cartridge identification card is connected to an interconnect card of the computer, then microcode of the printer is used to read and write to the memory device and to interact with the rest of the system. The GUI provides status levels 602 for the ink supply for each cartridge of each color. The user can also determine whether a newly installed ink cartridge has been recognized by the machine. If not, then the cartridge identification card may be faulty or the wrong cartridge may be installed.

The GUI may be used to provide informative user procedures for replacing 3L fluid cartridges. In the illustrated example, each of the eight color cartridges, two, an upper and a lower, for each color, Magenta, Black, Yellow, and Cyan, are shown for each of two printers, Printer 1 and Printer 2. A reset button 604 may be provided for each cartridge to give the user a single-click fluid content or fluid capacity reset function. This function sends a command from the operator through the user interface to the print management computer. The print management computer, in response to the reset command, resets the monitored fluid level for the respective fluid cartridge. The button may be provided only when a new 3L fluid cartridge is installed and detected using the cartridge identification card. This prevents the system from being set to an inoperative state.

The user reset function may be used to update the memory device 508 of the interconnect card 500 to account for the fluid amount in cartridge. For convenience, a reset all button 622 may be provided to allow the user to reset the level for all of the empty cartridges. This may be used when more than one cartridge has been replaced at one time. The operator may then go to the printer management computer 224 console 226 and reset all of the levels of the replaced cartridges to 100% with one button press. Additional buttons may also be provided such as OK 624 to exit the illustrated dialog box 600 and Cancel 626 to cancel any changes or exit the dialog box as shown, or to provide for other functions related to ink cartridges or other aspects of configuring, maintaining, servicing, and repairing the system. A variety of other resettable functions may be provided to suit different types of cartridges and printers.

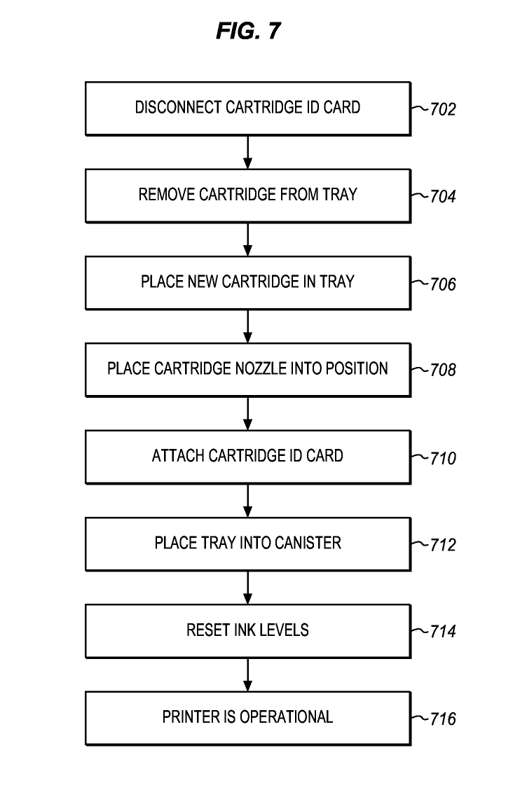

FIG. 7 is a process flow diagram of using a fluid cartridge as described herein presented from the perspective of the operator. At 702, a fluid cartridge identification card is disconnected from an interconnect card of a printer. At 704, the cartridge attached to the identification card is removed from a cartridge tray of the printer. At 706 a new fluid cartridge is placed into the now empty cartridge tray. This may be done by placing the fluid bag on a corresponding tray of the printer. At 708 a nozzle of the new fluid cartridge is put in place for connection to a fluid inlet of the printer.

At 710 a cartridge identification card attached to the fluid bag is attached over pins or some other retainer of the cartridge tray to make an electrical connection to the memory device of the interconnect card through a connector in the cartridge tray or ink canister. The filled cartridge tray is placed into the ink canister and if the correct card is used and electrically connected, then the interconnect card is switched on at 712 and recognizes the fluid cartridge. At 714, the operator may optionally reset the ink level using the system console for the machine. At 716, the printer is operational with the additional fluid supplies. Operations may be added or removed from this process flow and any other process, methods, or sequences of operations described herein. This process flow is provided only as a usage example for the apparatus described above.

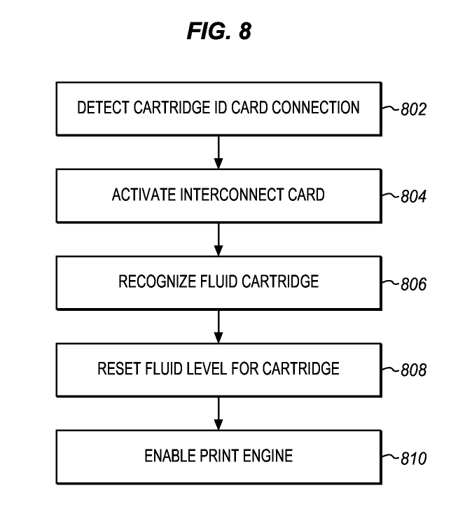

FIG. 8 is a process flow diagram of replacing a fluid cartridge considering the operations of the machine. At 802 after a fluid cartridge has been replaced and a corresponding fluid cartridge ID card is placed in a cartridge tray and the tray is returned to the ink canister, then the cartridge ID card makes a connection to the printer. The cartridge ID card interfaces with connectors in the canister to make an electrical connection to the memory device of the interconnect card. This may be done through a cable as shown in FIG. 2 or through any other type of connection. If the correct card is used and electrically connected, then at 804 the interconnect card is activated or switched on. Using the simple current loop as shown in FIG. 4, the memory device may be configured to only be activated when the expected to contacts of the cartridge ID card are activated. This current loop allows current to flow through a switch or a power circuit to activate the interconnect card. Alternatively a more complicated analog or digital system may be used to apply the ID data from the cartridge ID card to the interconnect card.

At 806 the fluid cartridge is recognized based on the received ID data from the cartridge ID card. A memory device of the interconnect card 216 recognizes the cartridge ID data 232. This data is then sent through an ink controller 218 of the main board 220 to the printer management computer. At 808 the fluid level for the corresponding cartridge is reset. This may be done automatically by the ink controller or the printer management computer when a new fluid cartridge is inserted and recognized. Alternatively, the operator may reset the ink level using the system console for the machine as shown in FIG. 6. At 810 the printer is enabled for use with the additional fluid supplies and a reset fluid level.

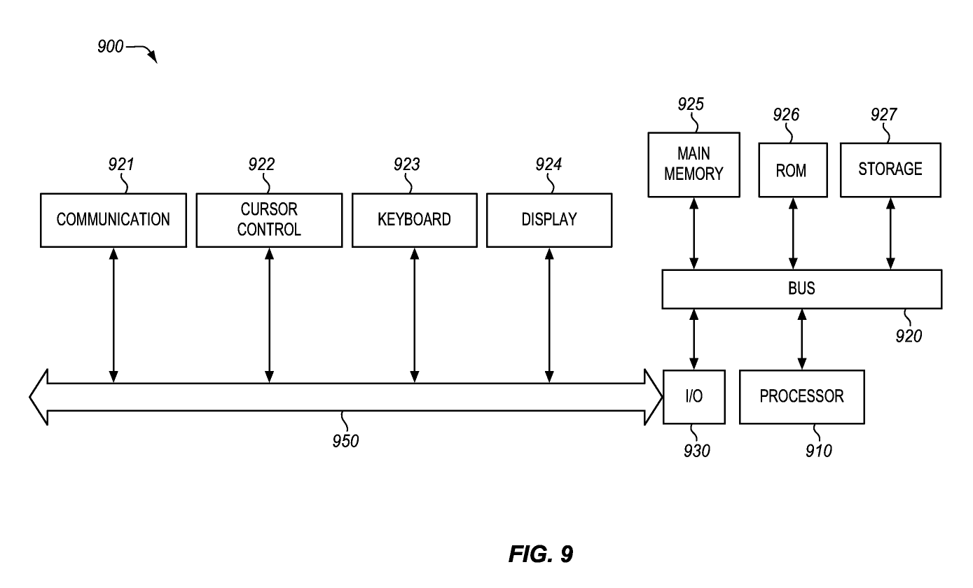

FIG. 9 illustrates a computer system 900 on which a print controller 140 and/or host system 110 may be implemented. Computer system 900 includes a system bus 920 for communicating information, and a processor 910 coupled to bus 920 for processing information.

Computer system 900 further comprises a random access memory (RAM) or other dynamic storage device 925 (referred to herein as main memory), coupled to bus 920 for storing information and instructions to be executed by processor 910. Main memory 925 also may be used for storing temporary variables or other intermediate information during execution of instructions by processor 910. Computer system 900 also may include a read only memory (ROM) and or other static storage device 926 coupled to bus 920 for storing static information and instructions used by processor 910.

A data storage device 927 such as a magnetic disk or optical disc and its corresponding drive may also be coupled to computer system 900 for storing information and instructions. Computer system 900 can also be coupled to a second I/O bus 950 via an I/O interface 930. A plurality of I/O devices may be coupled to I/O bus 950, including a display device 924, an input device (e.g., an alphanumeric input device 923 and or a cursor control device 922). The communication device 921 is for accessing other computers (servers or clients). The communication device 921 may comprise a modem, a network interface card, or other well-known interface device, such as those used for coupling to Ethernet, token ring, or other types of networks.

The techniques described herein are optimized for use with ink bag cartridges. However, the same or similar apparatus and techniques may also be used with other forms of replaceable fluid containers and with other types of information interfaces.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A printer cartridge comprising:
a fluid container;
a nozzle attached to the fluid container to provide fluid from the container to a printer;
a printed circuit board (PCB) holder;
a strap having a first end attached to the fluid container and a second end attached to the card holder; and
a cartridge identification PCB inserted into the card holder to identify the fluid in the fluid container to the printer when the cartridge identification card is connected to the printer.

2. The printer cartridge of claim 1, wherein the cartridge identification PCB comprises a printed circuit with a plurality of contact pads and a current loop between at least two of the contact pads.

3. The printer cartridge of claim 2, wherein the current loop identifies the contents of the fluid container.

4. The printer cartridge of claim 3, wherein the contact pads are configured to connect with an interconnect card of a memory device of the printer.

5. The printer cartridge of claim 1, wherein the strap comprises a strip bonded to the fluid container.

6. The printer cartridge of claim 1, wherein the fluid container is a bag for containing ink.

7. The printer cartridge of claim 1, wherein the cartridge identification PCB connects to the printer through a connector in an ink canister of the printer that holds the fluid cartridge, the connector having a cable connection to an interconnect card of the printer to identify the cartridge.

8. The printer cartridge of claim 1, wherein the holder is adapted to be fastened to an ink drawer of the printer via one or more pins.

9.-17. (canceled)
